(19) United States
(12) Patent Application Publication
(10) Pub. No.: US 2013/0157217 A1
(43) Pub. Date: Jun. 20, 2013

(54) DENTAL IMPLANT REUSABLE BITE REGISTRATION POST

(71) Applicant: Dene S. LeBeau, Renton, WA (US)

(72) Inventor: Dene S. LeBeau, Renton, WA (US)

(21) Appl. No.: 13/715,474

(22) Filed: Dec. 14, 2012

Related U.S. Application Data
(60) Provisional application No. 61/576,249, filed on Dec. 15, 2011.

(51) Int. Cl. A61C 19/05

(52) U.S. Cl. CPC A61C 19/05
USPC 433/68

(57) ABSTRACT

A bite registration post (10) includes a circular shank portion (12) that terminates at a lower threaded stem (14). The post includes an upper fixed diameter portion (20) and a lowered tapered portion (18) that tapers in diameter in the direction towards the threaded stem (14). A pair of spaced-apart, enlarged circular flanges are positioned along the shank at a location distal from the threaded stem (14).

### CROSS-REFERENCE TO RELATED APPLICATION

This application claims the benefit of U.S. Provisional Patent Application No. 61/576,249, filed Dec. 15, 2011, the specification of which is incorporated herein in its entirety.

### TECHNICAL FIELD

The present invention pertains to dental implants, and more particularly to posts used in conjunction with dental implants to obtain an accurate bite registration used when restoring a patient's occlusion.

### BACKGROUND

When restoring a patient's occlusion via dental implant, it is necessary to relate how the patient's teeth occlude so that the laboratory that creates the dental abutment has a guide in articulating the upper and lower casts taken of the patient's mouth. Dental implant situations provide a dilemma to the practitioner because there are no teeth or preparation of a tooth for the clinician to use to make a bite record. As a consequence, it is common to seek to use the healing cap as a surrogate for the tooth perforation when seeking to obtain the patient's bite. Unfortunately, the healing cap is rather small, and often recessed in gum tissue, causing at least part of the bite record to be taken on soft tissue, which is not a stable basis for the bite. As such, bites cannot be set on healing caps alone, and the tissue adjacent the bite cap does not result in an accurate bite record. Moreover, use of healing caps for referencing a bite registration requires the clinician to supply a second set of healing caps to the laboratory preparing the dental implant to enable the laboratory to set the bite on the model of the patient's mouth at the laboratory. This increases the cost of the dental implant procedure.

Thus, there is a need for a straightforward and cost-effective system for achieving accurate bite records for use in producing dental implants having an accurate bite registration.

### SUMMARY

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

The present invention pertains to bite registration posts for use in obtaining an accurate bite record in conjunction with the dental implant procedure. The bite registration posts include an elongated shank, and a threaded stem portion extending from one end of the shank. The threaded stem portion being threadably engageable in the implant in place in the patient's jaw. At least one relatively planar flange extends radially outwardly from the shank. The flange embeds in the bite material used to create the bite impression. Such material is typically set up as a relatively soft memory-retaining material that can be readily navigated on and off the bite registration post without any change in the bite.

In a further aspect of the present invention, the at least one flange is circular in shape in the direction extending outwardly from the shank. Moreover, the perimeter of the at least one flange is rounded or curved in a direction transverse to the diameter of the flange.

In a further aspect of the present invention, at least two flanges are positioned along the elongated shank, with the flanges spaced apart from each other. The spaced-apart flanges define an undercut therebetween. This undercut provides resistance or opposition to the movement of the bite material in 360 degrees about the axis of the bite registration posts.

In a further aspect of the present invention, the shank portion of the bite registration post is tapered from a larger width or diameter to a smaller width or diameter in the direction toward the threaded stem. This reduces the mass or weight of the bite registration post.

In a further aspect of the present invention, the diameter of the shank at the intersection of the threaded stem is larger in diameter than the diameter of the threaded stem. This defines a shoulder or annular face that extends transversely to the length of the post. When the stem is threaded into the insert the shoulder bottoms on the top of the insert when the post is fully engaged.

In another aspect of the present invention, a socket is formed in the end of the shank opposite the stem. This socket is sized in shape to receive a standard Allen wrench or other type of tool which may be used to remove the bite registration post from the abutment, if needed.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 illustrates bite registration posts screwed into the heads or top portions of dental implants placed in an upper jaw;

FIG. 2 shows bite registration posts screwed into the heads or top portions of dental implants in a lower jaw;

FIG. 3 is a pictorial view of a bite registration post;

FIG. 4 is a pictorial view of a second bite registration post;

FIG. 5 is a cross-sectional view of the bite registration post of FIG. 4;

FIG. 6 illustrates the bite registration posts and the bite mounted on a cast model of the patient's jaw; and

FIG. 7 is a cross-sectional view of a further bite registration post.

### DETAILED DESCRIPTION

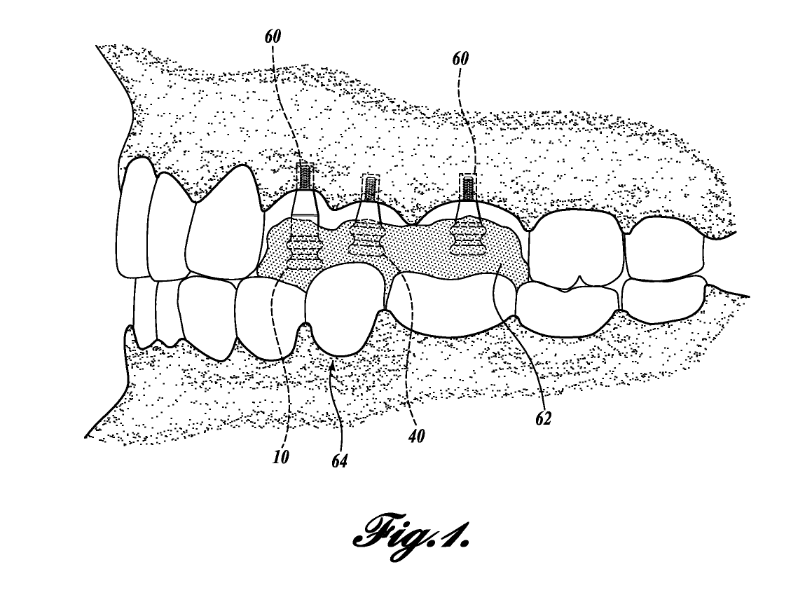

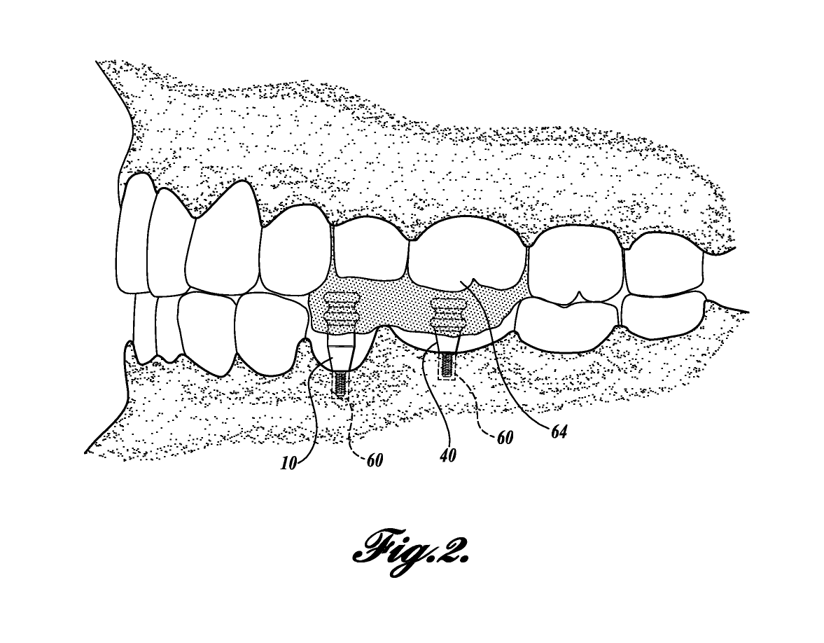

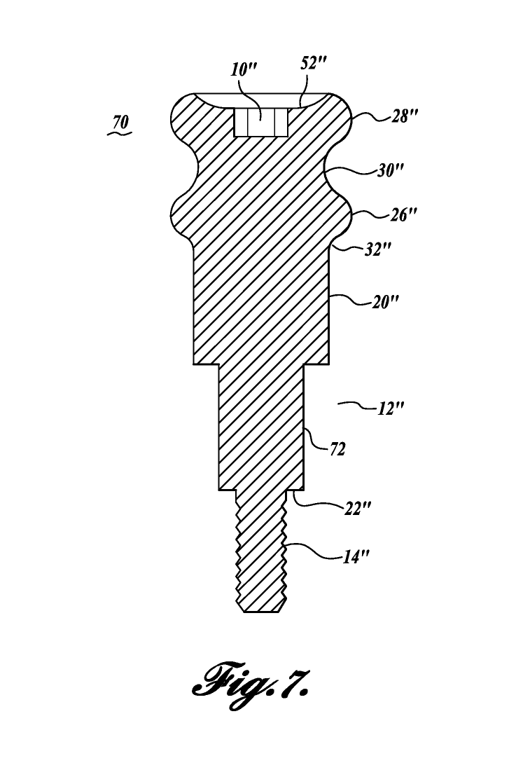

The present invention, as shown in FIGS. 1 and 2, is directed to bite registration posts 10 and 40 that screw into dental implants 60 to provide a stable platform for bite material 62 to be held between the posts and the opposing teeth 64 while the jaws are occluding. After the flowable bite material 62 sufficiently sets up, the resulting bite record can be used to set the model 66 of the patient's upper and lower teeth together virtually in the same manner as they are set in the mouth of the patient, see FIG. 6.

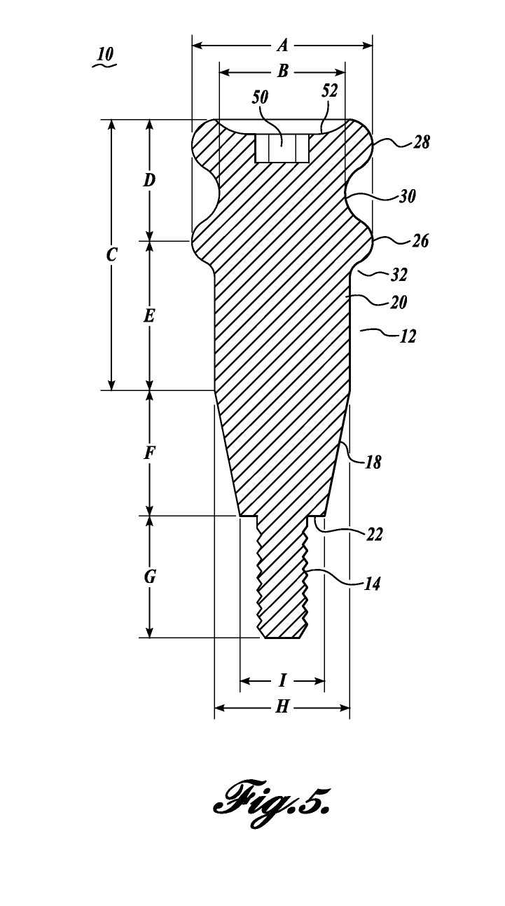

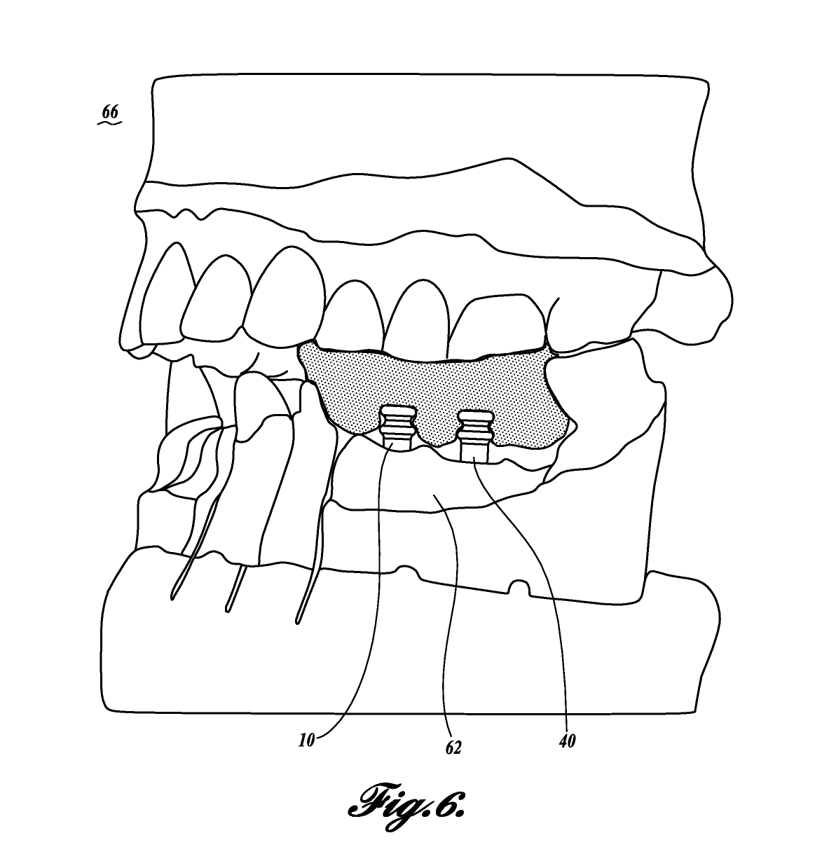

As shown in FIGS. 4 and 5, a bite registration post 10 includes a circular shank portion 12 that terminates at the adjacent end of a threaded lower stem 14 that screws into the head of an implant 60, located just below the soft tissue, see FIGS. 1 and 2. In post 10, the shank portion 12 includes lower tapered portion 18 and an upper fixed diameter portion 20. Typically, the diameter of the bottom of the shank portion will be close to the diameter of the head or top portion of the implant 60 into which the post is screwed, see FIGS. 1 and 2. When the post 10 is screwed into place, the base of the shank lower portion 18 defines a shoulder or face portion 22 that mates face-to-face with the upper surface of the implant 16.

A pair of vertically spaced-apart, enlarged circular flange portions 26 and 28 are formed at the top of the post 10. The flange portions 26 and 28 provide an anchor or support for the flowable bite material 62 that typically has a paste type consistency. The registration posts “hold” the bite material stably in place while the jaws are occluding thereby to create an accurate bite record. In this regard, the flange portions 26 and 28 define an undercut 30 that helps hold the registration material stably in place in not only the direction lengthwise of the bit post 10, but also in the directions 360 degrees radially to the control axis of the post.

As shown in FIGS. 4 and 5, the first undercut 30 is defined by the separation between the upper and lower flanges 28 and 26. A second undercut 32 is defined by the lower surface of lower flange 26 and the shank 12. In actuality, post 10 defines a double undercut 30 and 32.

As most clearly shown in FIG. 5, the undercut 30 is arcuate so as to form a smooth transition between the undercut and the adjacent underside of upper flange 28 and adjacent upper side of lower flange 26. The minimum diameter of the undercut 30 may be similar to the diameter of shank upper portion 20, but could be larger or smaller in diameter than the diameter of upper shank portion 20.

Continuing to refer to FIG. 5, the outer perimeter of the upper and lower flanges 28 and 26 are rounded or curved so as to not present any sharp edges or corners and also to assist in removing the bite material from the posts after the bite registration has been recorded.

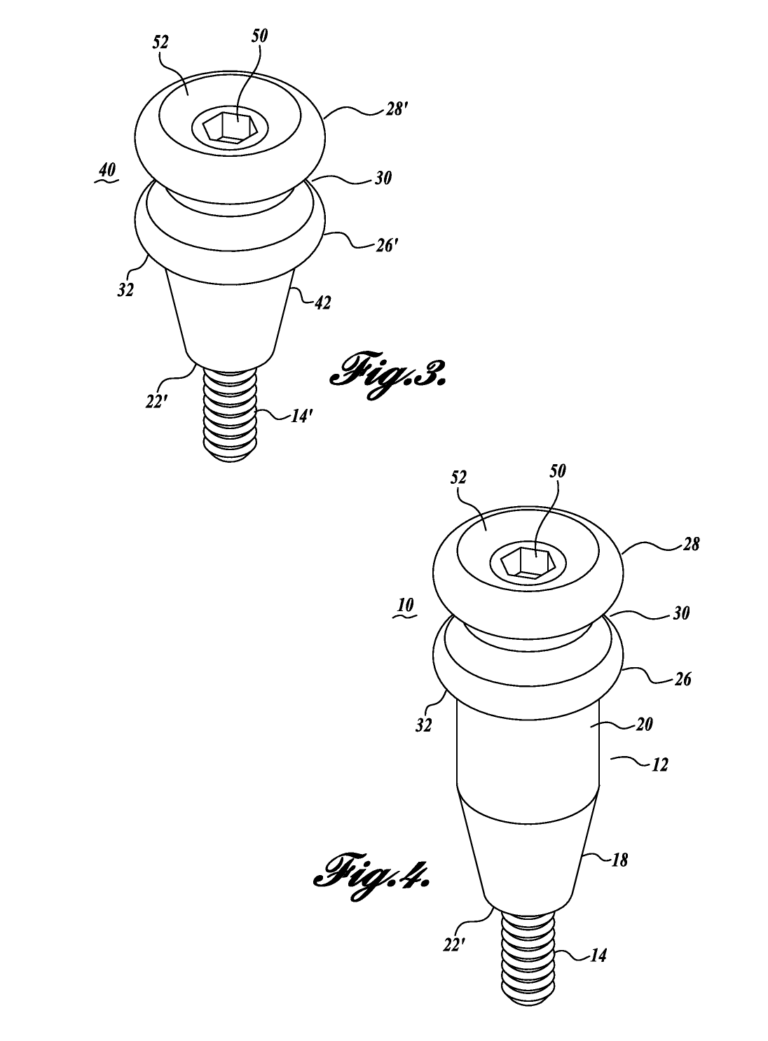

FIG. 3 shows a post 40 that is similar in construction, but shorter in length than post 10. Thus, post 40 can be used when there is a shorter distance between the implant and the tooth of the opposite jaw. It is important that the post not touch the teeth of the opposing jaw when the teeth are occluded.

In construction, post 40 differs primarily from post 10 in that post 40 does not have an upper constant diameter shank portion 20 in the manner of post 10. Rather, in post 40, shank 42 tapers from a larger diameter at the underside of lower flange 26′ to the diameter of shoulder 22′ at the lower end of the shank 42. Although the shank portion 42 is illustrated as uniformly tapering in the direction toward threaded stem 14′, the taper does not necessarily have to be uniform; rather, it can be variable along the length of the post 40. Other than these differences, bite post 40 is very similar in construction and function as bite post 10.

Both posts 10 and 40 include a socket 50 extending downwardly into the post from a recess 52 formed in the upper surface of upper flanges 28 and 28′, see FIGS. 3-5. As noted briefly below, the purpose of the socket is to receive a tool, such as an Allen wrench, that can be utilized for unscrewing or removing the post from either the implant in the patient's jaw or from the laboratory model of the patient's jaw, if need be. In this regard, the socket 50 can be in a form of a hex socket that is countersunk into the upper flange 28 or 28′. Of course, sockets of other shapes can be utilized. For example, the socket may be of a square shape or ovoid.

FIG. 5 provides dimensions A through I for the post 10 shown therein. As a non-limiting example, the dimensions shown in FIG. 5 may be as follows: A=5.5 millimeters (mm); B=4.0 mm; C=10.0 mm; D=4.0 mm; E=6.0 mm; F=2.7 mm; G=3.2 mm; H=4.2 mm; and I=2.5 mm. As noted above, the post 40 is similar to post 10 in construction but of a shorter length. In this regard, as a non-limiting example, dimension C of post 40 may be 6.5 mm, and dimension E may be 2.5 mm. However, it is to be understood that the dimensions of the features of the registration posts 10 and 40 shown in the figures are meant to be illustrative and not limiting.

Registration posts of other dimensions are within the scope of the present disclosure. Moreover, if a longer registration post is required, such post can be formed with three or other number of circular or other shaped, enlarged flanges. Such flanges can be similar to flanges 26 and 28 but of a number other than the two flanges as shown in FIGS. 3 and 4.

As noted above, the posts 10 and 40 may be removed from implants, such as implant 60, via Allen wrench or other tool that engages within a hex socket 30 countersunk into the top flange 28 of the registration posts 10 and 40. Further, rather than using a socket 30, it is possible to shape the upper flange 28 so as to receive a socket wrench or other tool that engages over the upper flange 28. In this regard, the upper flange may be of hex shape, square shape, or other shape.

Preferably, the bite posts 10 and 40 are composed of a durable and stable material so that the registration posts after use may be sterilized and repeatedly reused. One example of such material includes titanium. However, other materials, for instance ceramic, may also be used. Also, the bite posts 10 and 40 may be numbered or otherwise provided with a unique designation so that the posts can be placed into the model of the patient's jaw at the same location as in the patient's actual jaw. The number or designation can be inscribed in the recess 52 formed in the upper flanges 28/28′.

In use, the bite posts 10 and 40 are screwed into the implants 60 and then the flowable bite material 62 is applied to the implant area. The jaws are closed to force the bite material against the teeth 64 opposite the implant site. This causes the bite material to assume the shape of the tops of such oppositely located teeth when the teeth are occluded. During this process, the flowable bite material is held in place by the bite posts 10 and 40. After the bite material has sufficiently set up, the material is removed from the patient's mouth. The bite material is of sufficient elasticity to enable the bite material to be slid over the bite posts 10 and 40, but the bite material has sufficient memory to provide an accurate bite record. The bite posts are then removed from the implants 60.

Once the model 66 of the patient's jaws and existing teeth has been made, the bite posts 10 and/or 40 are screwed in place in the model 66 and the bite material 62 is placed over the posts. Thereupon, the model 66 can be articulated to indicate where the patient's teeth occlude.

A further embodiment of the present disclosure is illustrated in FIG. 7, wherein the bite post 70 is shown as being of a configuration similar to bite post 10. As such, the like portions of bite post 70 are numbered the same as in bite post 10, but with a double prime (″) designation. One difference between bite post 70 and bite post 10 is that the lower shank portion 72 of bite post 70 is not tapered in the manner of shank portion 18 of bite post 10. Rather, in bite post 70, the lower shank portion 72 is of a constant but smaller diameter than the upper shank portion 20″ of bite post 70. However, other than in this respect, bite post 70 is in construction and function very similar to bite post 10.

Further, it is to be understood that bite posts similar to bite post 70 can be constructed of various lengths. This can be accommodated by increasing or decreasing the length of the lower shank portion 72″ and/or the upper shank portion 20″. If a longer bite post is desired, such longer bite post may utilize more than two flanges, which may be similar or different in configuration from lower flange 26″ and upper flange 28″. Nonetheless, such alternative length bite posts still will function in the manner similar to bite posts 10, 40, and 70, described above.

While illustrative embodiments have been illustrated and described, it will be appreciated that various changes can be made therein without departing from the spirit and scope of the invention.

The embodiments of the invention in which an exclusive property or privilege is claimed are defined as follows:

1. Bite registration post comprising:
an elongated shank;
a threaded stem extending from one end of the shank; and
at least one flange extending radially outwardly from the width of the shank and positioned at a location along the shank distal from the threaded stem.

2. A bite registration post according to claim 1, wherein the at least one flange is circular in shape in the direction extending outwardly from the shank.

3. A bite registration post according to claim 2, wherein the outer perimeter of the at least one flange is curved in a direction transverse to the diameter of the at least one flange.

4. A bite registration post according to claim 1 comprising a first and second flanges spaced apart from each other along the length of the shank.

5. A bite registration post according to claim 4, wherein the first and second spaced-apart flanges define an undercut there between, the undercut having the width less than the outer diameters of the flanges.

6. A bite registration post according to claim 5, wherein said spaced-apart flanges are circular in shape in the direction transverse to the length of the shank, said first and second flanges defining an undercut of a diameter less than the diameter of the flanges.

7. A bite registration post according to claim 1, wherein the shank is tapered from a larger width to a smaller width at the intersection of the shank and the threaded stem.

8. A bite registration post according to claim 1, wherein a portion of the shank adjacent the stem is tapered to a smaller diameter adjacent the stem.

9. A bite registration post according to claim 1, wherein the shank at the intersection of the threaded stem defines the shoulder extending transversely to the length of the post.

10. A bite registration post according to claim 1, wherein a portion of the shank adjacent the threaded stem is of a reduced width from the width of the shank adjacent the at least one flange.

11. A bite registration post according to claim 1, wherein a socket is formed in the end of the shank opposite the threaded stem.

12. A bite registration post according to claim 1, wherein the at least one flange is formed at the end of the shank opposite the stem.

13. A bite registration post comprising:
a longitudinal shank;
a stem extending from one end of the shank, the stem adapted to engage the dental implant abutment; and
at least two circular flanges extending diametrically outwardly from the width of the shank and spaced apart along the length of the shank.

14. A bite registration post according to claim 13, wherein one of the at least two flanges is located at the end of the shank opposite the threaded stem.

15. A bite registration post according to claim 13, wherein the at least two flanges define an undercut there between, the undercut being of a diameter less than the outer diameter of the at least two flanges.

16. A bite registration post according to claim 13, wherein the outer periphery of the at least two flanges are rounded in the direction transverse to the diameters of the at least two flanges.

17. A bite registration post according to claim 13, further comprising a socket formed at the end of the shank opposite the location of the threaded stem.

18. A bite registration post according to claim 13, wherein the shank is circular in shape and tapers in diameter to reduced size adjacent the threaded stem.

19. A bite registration post according to claim 12, wherein the width of the shank adjacent the threaded stem is reduced from the width of the shank adjacent the two or more flanges.

20. A bite registration post according to claim 12, wherein a diameter of the threaded stem is less than the diameter of the adjacent portion of the shank, thereby defining a shoulder at the intersection of the shank and the reduced diameter threaded stem.
